(19) United States
(12) Patent Application Publication
(10) Pub. No.: US 2011/0008671 A1
(43) Pub. Date: Jan. 13, 2011

(54) NEGATIVE ELECTRODE FOR NONAQUEOUS BATTERY, ELECTRODE GROUP FOR NONAQUEOUS BATTERY AND METHOD FOR PRODUCING THE SAME, AND CYLINDRICAL NONAQUEOUS SECONDARY BATTERY AND METHOD FOR PRODUCING THE SAME

(76) Inventors: Masaharu Miyahisa, Osaka (JP); Seiichi Kato, Osaka (JP); Mao Yamashita, Osaka (JP)

Correspondence Address: MCDERMOTT WILL & EMERY LLP, 600 13TH STREET, NW, WASHINGTON, DC, 20005-3096, US

(21) Appl. No.: 12/922,333

(22) PCT Filed: Nov. 16, 2009
(86) PCT No.: PCT/JP2009/006117

§ 371 Date: Sep. 13, 2010

(30) Foreign Application Priority Data
Jan. 13, 2009 (JP) 2009-004213
Nov. 12, 2009 (JP) 2009-259085

(51) Int. Cl. H01M 10/0587; H01M 4/13; H01M 4/139; H01M 10/058

(52) U.S. Cl. 429/164; 429/209; 29/623.1

(57) ABSTRACT

A negative electrode for a nonaqueous battery includes a double-coated part (14) including a negative electrode active material layer (13) formed on each surface of a current collector core (12), a core exposed part (18) which is located at an end of the current collector core (12), and does not include the negative electrode active material layer (13), and a single-coated part (17) which is located between the double-coated part (14) and the core exposed part (18), and includes the negative electrode active material layer (13) formed only on one of the surfaces of the current collector core (12). A plurality of grooves (10) are formed in each surface of the double-coated part (14) to be inclined relative to a longitudinal direction of the negative electrode (3), while the grooves (10) are not formed in the single-coated part (17). A negative electrode current collector lead (20) is connected to the core exposed part (18). The negative electrode (3) is wound in such a manner that the core exposed part (18) constitutes a last wound end.

### TECHNICAL FIELD

The present invention particularly relates to a negative electrode for a nonaqueous battery, an electrode group including the negative electrode and a method for producing the same, and a cylindrical nonaqueous secondary battery including the electrode group and a method for producing the same.

### BACKGROUND ART

In recent years, cylindrical lithium secondary batteries have widely been used as driving power supplies for mobile electronic devices and communication devices. In such a cylindrical lithium secondary battery, in general, a carbon material capable of inserting and extracting lithium is used as a negative electrode, and a composite oxide of transition metal and lithium such as LiCoO₂ etc., is used as a positive electrode to provide the secondary battery with high potential and high discharge capacity. With increase of functions of the electronic devices and communication devices, batteries with higher capacity have been in demand.

To realize a high capacity lithium secondary battery, for example, the battery capacity can be increased by increasing a volume of the positive and negative electrodes contained in a battery case, and reducing empty space except for space occupied by the electrodes in the battery case. Further, the battery capacity can be increased by applying a mixture paste made of a material of the positive or negative electrode to a current collector core, drying the paste to form an active material layer, and pressing the active material layer at high pressure to be compressed to a predetermined thickness, thereby increasing a filling density of the active material.

When the filling density of the active material in the electrode increases, it would be difficult to penetrate a nonaqueous electrolyte, which is injected in a battery case and has a relatively high viscosity, into small gaps in an electrode group formed by winding or stacking the positive and negative electrodes at high density with a separator interposed therebetween. Accordingly, it requires a long time to impregnate the electrode group with a predetermined amount of the nonaqueous electrolyte. Further, with an increased filling density of the active material of the electrode, porosity of the electrode is reduced, thereby making penetration of the electrolyte into the electrode group difficult. Therefore, impregnation of the electrode group with the nonaqueous electrolyte is greatly impaired, thereby varying the distribution of the nonaqueous electrolyte in the electrode group.

To overcome this disadvantage, grooves for guiding the nonaqueous electrolyte are formed in a surface of a negative electrode active material layer along a penetrating direction of the nonaqueous electrolyte to allow the nonaqueous electrolyte to penetrate into the whole part of the negative electrode. When the width or depth of the grooves is increased, the impregnation can be done in a short time. However, this reduces the amount of the active material, and therefore, charge/discharge capacity may decrease, or a reaction between the electrodes may become nonuniform, thereby deteriorating battery characteristics. Taking these into consideration, a method for setting the width and depth of the grooves to predetermined values has been proposed (see, e.g., Patent Document 1).

However, the grooves formed in the surface of the negative electrode active material layer may cause break of the electrode when the electrode is wound to form the electrode group. Therefore, a method for preventing the break of the electrode while improving the impregnation has been proposed. In this method, the grooves are formed in the surface of the electrode to form an inclination angle with a longitudinal direction of the electrode in order to distribute tensile force applied in the longitudinal direction of the electrode when the electrode is wound to form an electrode group. This can prevent the break of the electrode (see, e.g., Patent Document 2).

Another method has also been proposed, although it is not intended to improve the impregnation with the electrolyte. In this method, a porous film having convex portions partially formed on a surface facing the positive or negative electrode is provided for the purpose of alleviating overheat caused by overcharge. Accordingly, a larger amount of the nonaqueous electrolyte is held in gaps between the convex portions of the porous film and the electrode than in the other parts, thereby inducing an overcharge reaction in the gaps in a concentrated manner. This can alleviate the overcharge of a battery, and can alleviate the overheat due to the overcharge (see, e.g., Patent Document 3).

Patent Document 1: Japanese Patent Publication No. H09-298057

Patent Document 2: Japanese Patent Publication No. H11-154508

Patent Document 3: Japanese Patent Publication No. 2006-12788

### SUMMARY OF THE INVENTION

### Technical Problem

According to the conventional method of Patent Document 2, the electrolyte can penetrate into the electrodes in a shorter time as compared with the case where the electrodes are not provided with grooves. However, the time required for the penetration cannot be greatly reduced because the grooves are formed in only one of the surfaces of the electrode. Thus, the penetration takes quite a long time, an amount of the electrolyte evaporated cannot easily be reduced, and the loss of the electrolyte cannot easily be reduced. Further, the grooves formed in only one of the surfaces of the electrode cause stress on the electrode. Therefore, the electrode tends to be curled on the side where the grooves are not formed.

According to the conventional method of Patent Document 3, the electrode group formed by winding the positive and negative electrodes with the separator interposed therebetween includes a useless, non-reactive portion which does not contribute to a battery reaction. Thus, space inside the battery case cannot effectively be used, thereby making the increase of the battery capacity difficult.

According to a method for forming the grooves in the surfaces of the active material layers formed on each surface of an electrode, a pair of rollers having a plurality of protrusions on their surfaces are arranged above and below the electrode, and the rollers are rotated and moved on the surfaces of the electrode while applying pressure thereto. In this method (hereafter referred to as “roll pressing”), a plurality of grooves can simultaneously be formed in each of the surfaces of the electrode. Therefore, this method is suitable for mass-production. The inventors of the present application have found the following problems as a result of examination of various types of electrodes including the grooves formed in the surfaces of the active material layers by roll pressing for the purpose of improving impregnation with the electrolyte.

FIGS. 11(a) to 11(c) are perspective views illustrating steps for producing an electrode 103. First, as shown in FIG. 11(a), an electrode hoop material 111 is formed which includes double-coated parts 114, each of which includes an active material layer 113 formed on each surface of a belt-like current collector core 112, single-coated parts 117, each of which includes the active material layer 113 formed on only one of the surfaces of the current collector core 112, and core exposed parts 118, each of which does not include the active material layer 113. Then, as shown in FIG. 11(b), a plurality of grooves 110 are formed in the surfaces of the active material layers 113 by roll pressing. Then, as shown in FIG. 11(c), the electrode hoop material 111 is cut at boundaries of the double-coated parts 114 and the core exposed parts 118. Thereafter, a current collector lead 120 is connected to each of the core exposed parts 118. Thus, the electrodes 103 are produced. However, as shown in FIG. 12, when the electrode hoop material 111 is cut at the boundary of the double-coated part 114 and the core exposed part 118, the core exposed part 118 and the single-coated part 117 continuous with the core exposed part are greatly deformed into a curved shape.

A possible cause of this phenomenon is as follows. The roll pressing is performed by continuously passing the electrode hoop material 111 through a gap between the rollers. Therefore, the grooves 110 are formed in each of the surfaces of the active material layers 113 of the double-coated part 114, and are formed also in the surface of the active material layer 113 of the single-coated part 117. Specifically, when forming the grooves 110, the active material layer 113 stretches. In the double-coated part 114, the active material layers 113 formed on the surfaces of the electrode stretch to the same extent. In the single-coated part 17, in contrast, the active material layer 113 stretches only on one of the surfaces thereof. Thus, due to tensile stress of the active material layer 113, the single-coated part 117 is greatly deformed to curve on the side on which the active material layer 113 is not formed.

If an end part of the electrode 103 (including the core exposed part 118 and the single-coated part 117 continuous with the core exposed part 118) is curved by cutting the electrode hoop material 111, the electrodes 103 may be misaligned when they are wound to form an electrode group. Further, in the case where the electrode group is formed by stacking the electrodes, the electrodes may possibly be bent. Furthermore, the end part of the electrode 103 may not reliably be chucked in transferring the electrode 103, resulting in failure in transfer of the electrode 103, or falling of the active material. This may reduce not only productivity, but also reliability of the batteries.

In view of the above-described problems, the present invention has been achieved. An object of the invention is to provide a negative electrode for a nonaqueous battery which allows good impregnation with an electrolyte, and has high productivity and reliability, an electrode group for the nonaqueous battery and a method for producing the same, and a cylindrical nonaqueous secondary battery and a method for producing the same.

### Solution to the Problem

A negative electrode for a nonaqueous battery of the present invention includes an active material layer formed on a surface of a current collector core. The negative electrode includes: a double-coated part which includes the active material layer formed on each surface of the current collector core; a core exposed part which is located at an end of the current collector core, and does not include the active material layer; and a single-coated part which is located between the double-coated part and the core exposed part, and includes the active material layer formed only on one of the surfaces of the current collector core. A plurality of grooves are formed in each surface of the double-coated part to be inclined relative to a longitudinal direction of the negative electrode, while the grooves are not formed in the single-coated part. A negative electrode current collector lead is connected to the core exposed part, and the negative electrode is wound in such a manner that the core exposed part constitutes a last wound end.

The above-described configuration can improve impregnation with an electrolyte, thereby reducing time required for the impregnation.

Further, a useless portion which does not contribute to a battery reaction can be eliminated, and tensile force applied by the negative electrode active material layer formed in the single-coated part can be alleviated. This can prevent the core exposed part and the single-coated part continuous with the core exposed part from greatly deforming into a curved shape.

The electrode group can be provided with an almost perfect circular cross-section. This makes a distance between the negative and positive electrodes of the electrode group uniform, thereby improving cycle characteristics.

In the negative electrode for the nonaqueous battery of the present invention, a phase of the grooves formed in one of the surfaces of the double-coated part is preferably symmetric with a phase of the grooves formed in the other surface of the double-coated part. This can reduce damage to the negative electrode caused by forming the grooves in the negative electrode as much as possible, and can prevent break of the negative electrode when the negative electrode is wound to form an electrode group.

In the negative electrode for the nonaqueous battery of the present invention, a depth of the grooves formed in each of the surfaces of the double-coated part is preferably in the range of 4 μm to 20 μm. This can improve penetration of the electrolyte, and can prevent the active material from falling.

In the negative electrode for the nonaqueous battery of the present invention, the grooves formed in each of the surfaces of the double-coated part are preferably arranged at a pitch of 100 μm to 200 μm in the longitudinal direction of the negative electrode. This can reduce damage to the negative electrode caused by forming the grooves in the negative electrode as much as possible.

In the negative electrode for the nonaqueous battery of the present invention, the grooves formed in each of the surfaces of the double-coated part preferably extend from one lateral end to the other lateral end of the negative electrode. This allows easy impregnation of the electrode group with the electrolyte from an end face of the electrode group, thereby reducing time required for the impregnation.

In the negative electrode for the nonaqueous battery of the present invention, the grooves formed in one of the surfaces of the double-coated part, and the grooves formed in the other surface of the double-coated part are preferably inclined at an angle of 45° relative to the longitudinal direction of the negative electrode in different directions, so as to extend in directions crossing each other at right angles. This can avoid the formation of the grooves running in the direction which allows easy break of the negative electrode, thereby preventing concentration of stress. Thus, the break of the negative electrode can be prevented.

In the negative electrode for the nonaqueous battery of the present invention, the current collector lead, and the active material layer of the single-coated part are preferably arranged on the opposite surfaces of the current collector core. This allows provision of the electrode group with an almost perfect circular cross-section. Therefore, a distance between the negative and positive electrodes of the electrode group becomes uniform, thereby improving cycle characteristics.

An electrode group for a nonaqueous battery of the present invention includes the negative electrode for the nonaqueous battery of the present invention, and the single-coated part of the negative electrode constitutes an outermost turn of the electrode group.

In the electrode group for the nonaqueous battery of the present invention, the surface of the current collector core in the single-coated part of the negative electrode on which the active material layer is not formed preferably constitutes an outermost circumferential surface of the electrode group. This can prevent useless provision of the active material layer on a portion of the electrode group which does not contribute to the battery reaction when the battery is working.

In a method for producing the electrode group for the nonaqueous battery of the present invention, the positive electrode and the negative electrode for the nonaqueous battery of the present invention are wound with a separator interposed therebetween in such a manner that the core exposed part of the negative electrode constitutes a last wound end.

A cylindrical nonaqueous secondary battery of the present invention includes the electrode group for the nonaqueous battery of the present invention.

### Advantages of the Invention

According to the present invention, a plurality of grooves inclined relative to the longitudinal direction of the negative electrode are formed in each of the surfaces of the double-coated part, while the grooves are not formed in the single-coated part. This can improve the impregnation with the electrolyte, and can prevent the core exposed part and the single-coated part continuous with the core exposed part of the negative electrode from significantly deforming in the curved shape.

Since the winding is performed in such a manner that the core exposed part of the negative electrode current collector core to which the negative electrode current collector lead is connected constitutes a last wound end, the negative electrode current collector lead would not form a protrusion at the innermost turn of the electrode group, thereby providing the electrode group with an almost perfect circular cross-section. Thus, a distance between the positive and negative electrodes of the electrode group becomes uniform, thereby improving cycle characteristics.

As described above, a negative electrode for a nonaqueous battery which allows good impregnation with an electrolyte, and has high productivity and reliability, an electrode group for the nonaqueous battery, and a cylindrical nonaqueous secondary battery can be provided.

### BRIEF DESCRIPTION OF THE DRAWINGS

FIG. 1 is a vertical cross-sectional view illustrating the structure of a cylindrical nonaqueous secondary battery according to an embodiment of the present invention.

FIG. 2(a) is a perspective view illustrating a negative electrode hoop material in the step of producing a negative electrode for a battery according to the embodiment of the invention, FIG. 2(b) is a perspective view illustrating the negative electrode hoop material provided with grooves formed in the step, and FIG. 2(c) is a perspective view illustrating a negative electrode formed in the step.

FIG. 3 is a transverse cross-sectional view illustrating part of an electrode group according to the embodiment of the present invention.

FIG. 4 is a partially enlarged plan view illustrating the negative electrode for the battery according to the embodiment of the present invention.

FIG. 5 is an enlarged cross-sectional view taken along the line A-A of FIG. 4.

FIG. 6 is a perspective view illustrating a process for forming grooves in each surface of a double-coated part according to the embodiment of the present invention.

FIG. 7 is a view schematically illustrating the general structure of an apparatus for producing the negative electrode for the battery according to the embodiment of the present invention.

FIG. 8 is an enlarged perspective view illustrating the structure of a groove forming mechanism 28 according to the embodiment of the present invention.

FIG. 9(a) is a vertical cross-sectional view illustrating the structure of groove forming rollers according to the embodiment of the present invention, FIG. 9(b) is a cross-sectional view of the groove forming rollers according to the embodiment (FIG. 9(a)) taken along the line B-B, and FIG. 9(c) is a cross-sectional view of a groove forming protrusion of the groove forming rollers according to the embodiment.

FIG. 10 is a side view illustrating the groove forming mechanism according to the embodiment of the present invention.

FIG. 11(a) is a perspective view illustrating a negative electrode hoop material in the step of producing a conventional negative electrode for a battery, FIG. 11(b) is a perspective view illustrating the negative electrode hoop material provided with grooves formed in the step, and FIG. 11(c) is a perspective view illustrating the negative electrode formed in the step.

FIG. 12 is a perspective view illustrating problems of the conventional negative electrode for the battery.

### DESCRIPTION OF EMBODIMENTS

An embodiment of the present invention will be described below in detail with reference to the drawings. In the drawings, components having substantially the same function are indicated by the same reference characters for the sake of easy description. The present invention is not limited to the following embodiment.

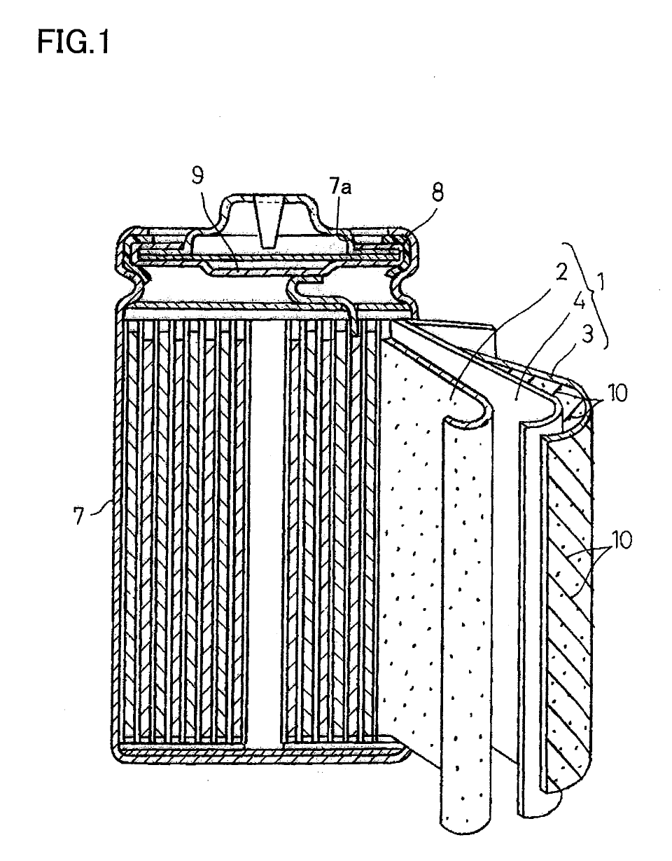

The structure of a cylindrical nonaqueous secondary battery produced by a production apparatus of the present embodiment will be described with reference to FIG. 1. FIG. 1 is a vertical cross-sectional view schematically illustrating the cylindrical nonaqueous secondary battery of the present embodiment. The cylindrical nonaqueous secondary battery includes an electrode group 1 formed by winding a positive electrode 2 containing lithium composite oxide as an active material, and a negative electrode 3 containing a material capable of holding lithium as an active material into spiral form, with a separator 4 interposed therebetween. The electrode group 1 is placed in a cylindrical battery case 7 having a closed end, and an electrolyte (not shown) constituted of a predetermined amount of a nonaqueous solvent is injected in the battery case 7 to impregnate the electrode group 1 with the electrolyte. An opening of the battery case 7 is bent radially inward, and is crimped onto a sealing plate 9 which is inserted in the opening, and has a gasket 8 attached to a circumference thereof, thereby hermetically sealing the battery case. In the cylindrical nonaqueous secondary battery, a plurality of grooves 10 are formed in each surface of the negative electrode 3 in such a manner that the grooves 10 formed in one of the surfaces, and the grooves 10 formed in the other surface extend in the directions crossing each other. The electrolyte is allowed to penetrate through the grooves 10, thereby improving impregnation of the electrode group 1 with the electrolyte.

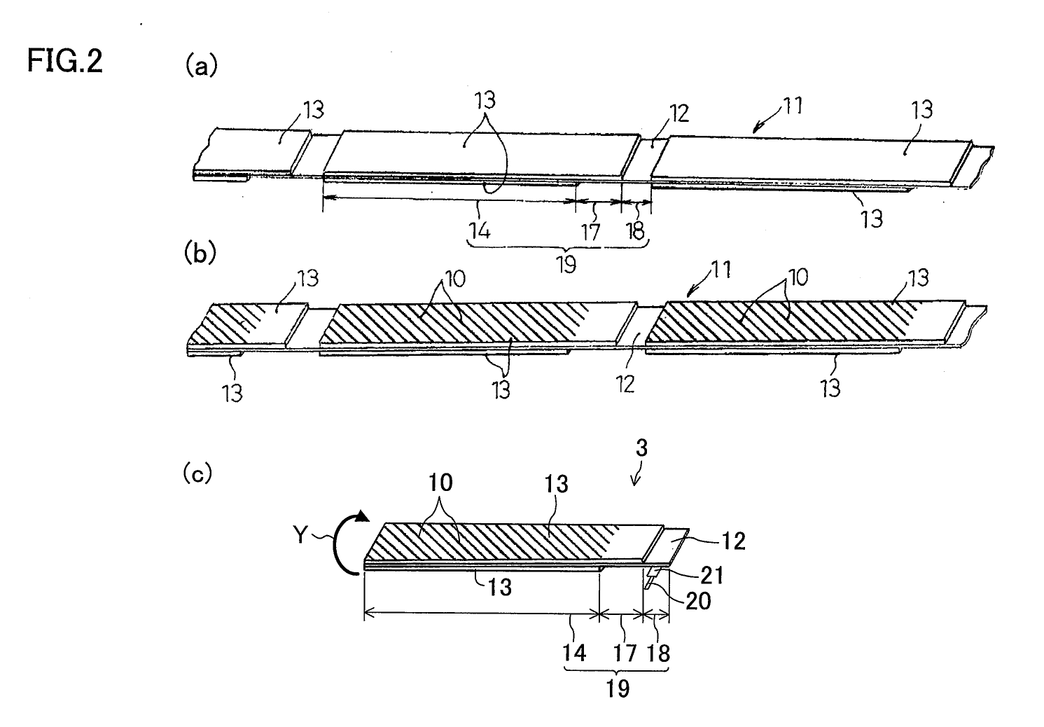

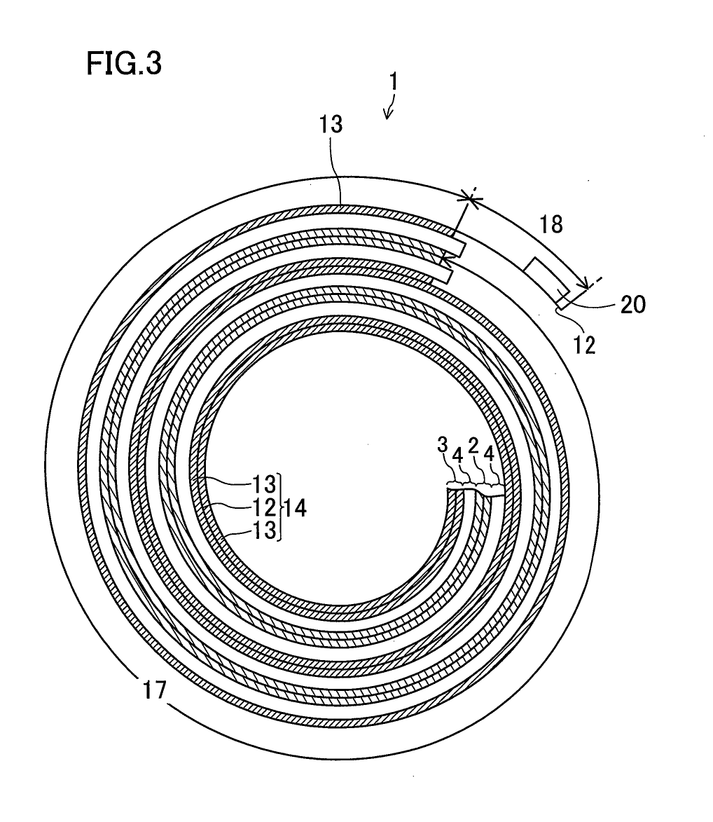

FIGS. 2(a) to 2(c) are perspective views illustrating the steps of producing the negative electrode 3. FIG. 3 is a transverse cross-sectional view illustrating part of the electrode group 1. FIG. 2(a) illustrates a negative electrode hoop material 11 before being divided into the negative electrodes 3. The negative electrode hoop material 11 is formed by applying a negative electrode mixture paste to each surface of a current collector core 12 made of 10 μm thick, long strip-shaped copper foil, drying the paste, pressing the resulting current collector core 12 to be compressed to a total thickness of 200 μm to form negative electrode active material layers 13, and cutting the obtained product into strips of about 60 mm in width. The negative electrode mixture paste may be paste obtained by mixing, for example, artificial graphite as an active material, styrene-butadiene copolymer rubber particle dispersion as a binder, and carboxymethyl cellulose as a thickener, with a proper amount of water.

In the negative electrode hoop material 11, a double-coated part 14 which includes the negative electrode active material layer 13 formed on each surface of the current collector core 12, a single-coated part 17 which includes the negative electrode active material layer 13 formed only on one of the surfaces of the current collector core 12, and a core exposed part 18 which does not include the negative electrode active material layer 13 on the current collector core 12 are provided, thereby constituting an electrode component part 19. The negative electrode hoop material 11 includes a multiple ones of the electrode component part 19 continuously formed in a longitudinal direction thereof. The electrode component part 19 in which the negative electrode active material layer 13 is partially provided can easily be formed by applying the negative electrode active material layer 13 by a known intermittent application process.

FIG. 2(b) illustrates the negative electrode hoop material 11 in which the grooves 10 are formed only in the surfaces of the negative electrode active material layers 13 formed on the surfaces of each of the double-coated parts 14, while the grooves 10 are not formed in the negative electrode active material layer 13 of each of the single-coated parts 17. The negative electrode hoop material 11 provided with the grooves 10 is cut by a cutter at the core exposed parts 18 adjacent to the double-coated parts 14 to be divided into the electrode component parts 19 as shown in FIG. 2(c). Then, a negative electrode current collector lead 20 is welded to the current collector core 12 of the core exposed part 18, and the current collector lead 20 is coated with an insulation tape 21. Thus, a negative electrode 3 for a cylindrical nonaqueous secondary battery is produced.

The negative electrode 3 produced in this manner includes, as shown in FIG. 2(c), the double-coated part 14, the single-coated part 17, and the core exposed part 18. A plurality of grooves 10 inclined relative to the longitudinal direction of the negative electrode 3 are formed in each of the surfaces of the double-coated part 14, while the grooves 10 are not formed in the single-coated part 17. The core exposed part 18 is located at an end of the negative electrode 3 (specifically, at a longitudinal end of the negative electrode 3), and the negative electrode current collector lead 20 is connected to the core exposed part 18. The negative electrode 3 and the positive electrode 2 are wound into spiral form in the direction of an arrow Y with the separator 4 interposed therebetween, thereby constituting the electrode group 1 of the present embodiment.

The negative electrode 3 configured in the above-described manner offers the following advantages. Specifically, the grooves 10 are not formed in the negative electrode active material layer 13 of the single-coated part 17. Therefore, when cutting the negative electrode hoop material 11 into the electrodes as shown in FIG. 2(c), the core exposed part 18 and the single-coated part 17 continuous with the core exposed part 18 of the negative electrode 3 can be prevented from being greatly deformed into a curved shape. This can prevent misalignment when the positive electrode 2 and the negative electrode 3 are wound to form the electrode group 1. Further, when winding the negative electrode 3 by a winding device, troubles in transferring the electrode, such as failure in chucking, and falling of the negative electrode active material, can be prevented because the electrode is prevented from being greatly deformed into a curved shape. This makes it possible to provide a negative electrode for a battery which shows good impregnation with an electrolyte, and has high productivity and reliability.

When the negative electrode 3 and the positive electrode 2 are wound into spiral form with the separator 4 interposed therebetween to constitute the electrode group 1, the electrodes are wound in such a manner that the core exposed part 18 to which the negative electrode current collector lead 20 is attached constitutes a last wound end as shown in FIG. 2(c). Thus, a protrusion derived from the negative electrode current collector lead 20 will not be formed at the inner turn of the electrode group 1. Therefore, the electrode group 1 can be provided with an almost perfect circular cross-section. This allows easy placement of the electrode group 1 in the battery case 7. Further, in the electrode group 1, a distance between the negative electrode 3 and the positive electrode 2 is made uniform, thereby improving cycle characteristics.

When the negative electrode 3 and the positive electrode 2 are wound into spiral form with the separator 4 interposed therebetween to constitute the electrode group 1, the electrodes are wound in such a manner that the core exposed part 18 to which the negative electrode current collector lead 20 is attached constitutes a last wound end, and that a surface of the single-coated part 17 of the negative electrode 3 on which the negative electrode active material layer 13 is not formed constitutes an outermost circumferential surface of the electrode group 1 as shown in FIG. 3. The outermost circumferential surface of the electrode group 1 does not face the positive electrode 2. Therefore, when the surface of the single-coated part 17 of the negative electrode 3 on which the negative electrode active material layer 13 is not formed constitutes the outermost circumferential surface of the electrode group 1, useless provision of the negative electrode active material layer 13 on a portion which does not contribute to a battery reaction when the battery is working can be avoided. This allows efficient use of space inside the battery case 7, thereby improving battery capacity.

Further, the negative electrode current collector lead 20 is connected to the surface of the core exposed part 18 of the negative electrode 3 opposite the surface of the single-coated part 17 on which the negative electrode active material layer 13 is formed (i.e., on the outermost circumferential surface of the electrode group 1). Thus, the obtained electrode group 1 can be provided with an almost perfect circular cross-section. This allows easy placement of the electrode group 1 in the battery case 7, and improves the cycle characteristics to a further extent.

Moreover, with the negative electrode current collector lead 20 located on the outermost circumferential surface of the electrode group 1, the negative electrode current collector lead 20 can be prevented from peeling from the negative electrode 3 even if an end of the negative electrode current collector lead 20 is bent to be welded to a bottom surface of the battery case 7. Thus, the negative electrode current collector lead 20 can be welded to the bottom surface of the battery case 7 without causing great stress to the welded joint between the negative electrode current collector lead 20 and the current collector core 12.

As described later in Example 1, the positive electrode 2 includes a positive electrode active material layer containing lithium composite oxide formed on each surface of a positive electrode current collector core.

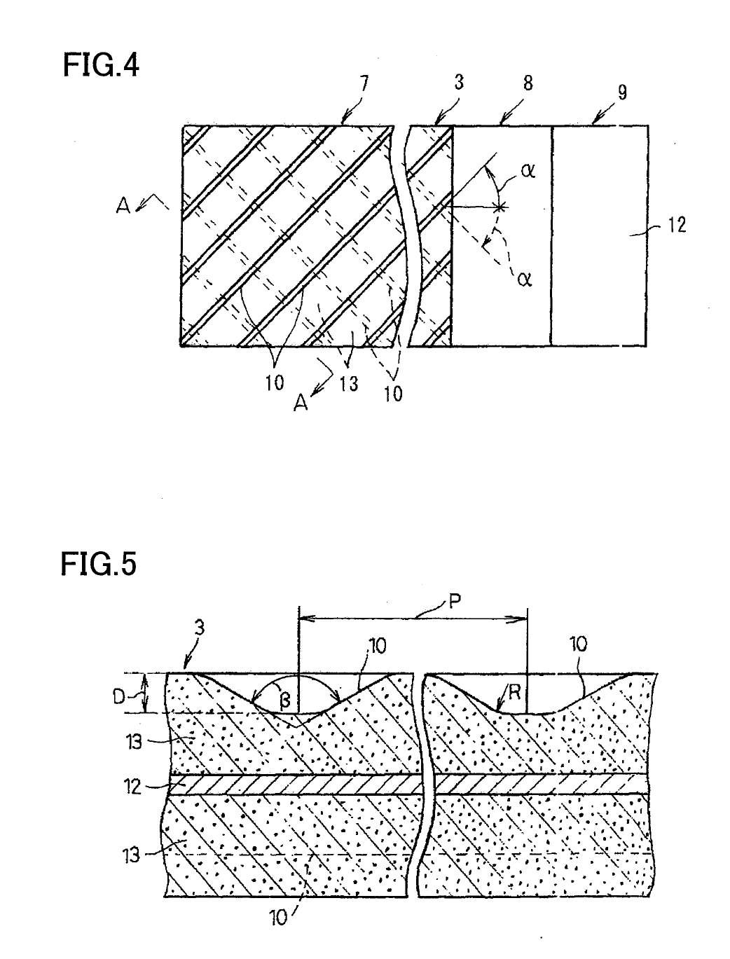

FIG. 4 is an enlarged plan view partially illustrating the negative electrode 3 of the present embodiment. The grooves 10 formed in the negative electrode active material layer 13 on one of the surfaces of the double-coated part 14, and the grooves 10 formed in the negative electrode active material layer 13 on the other surface of the double-coated part 14 are arranged at an inclination angle α of 45° relative to the longitudinal direction of the negative electrode 3 in different directions, so as to extend in directions crossing each other at right angles. On each of the surfaces of the double-coated part 14, the grooves 10 are arranged parallel to each other at the same pitch, and every groove 10 is formed to extend from one end to the other end of the negative electrode active material layer 13 in the lateral direction (a direction orthogonal to the longitudinal direction). The inclination angle α is not limited to 45°, and it may be in the range of 30° to 90°. In this case, a phase of the grooves 10 formed in the one of the surfaces of the double-coated part 14 may be symmetric with a phase of the grooves 10 formed in the other surface of the double-coated part 14, in such a manner that the grooves 10 in each of the surfaces extend in the directions crossing each other.

The grooves 10 will be described in detail with reference to FIG. 5. FIG. 5 is an enlarged cross-sectional view taken along the line A-A in FIG. 4, illustrating the cross-sectional shape of the grooves 10, and an arrangement pattern of the grooves 10. The grooves 10 are formed at a pitch P of 170 μm in each of the surfaces of the double-coated part 14. Each of the grooves 10 has a substantially inversed trapezoidal cross section. In this embodiment, each of the grooves 10 has a depth D of 8 μm, and sidewalls thereof are inclined at an angle β of 120°. Corners formed by the bottom surface and the sidewalls of the groove 10 are arc-shaped to have a curvature R of 30 μm when viewed in cross section.

The pitch P of the grooves 10 will be described. When the pitch P of the grooves 10 is small, a large number of grooves 10 can be formed to increase the total cross-sectional area of the grooves 10, thereby improving the penetration of the electrolyte. To examine this relationship, three types of negative electrodes 3 were formed, in which the depth D of the grooves 10 was fixed to 8 μm, while the pitch P was changed to 80 μm, 170 μm, and 260 μm. Then, three types of electrode groups 1 using the negative electrodes 3, respectively, were placed in the battery cases 7 to compare time required for the penetration of the electrolyte. As a result, the penetration time was about 20 minutes when the pitch P was 80 μm, about 23 minutes when the pitch P was 170 μm, and about 30 minutes when the pitch P was 260 μm. This indicates that the smaller pitch P of the grooves 10 allows faster penetration of the electrolyte into the electrode group 1.

When the pitch P of the grooves 10 is set smaller than 100 μm, the penetration of the electrolyte improves. However, the negative electrode active material layer 13 is compressed at many portions thereof due to the increased number of grooves 10, thereby increasing the filling density of the active material too much. Further, a planar area in the surface of the negative electrode active material layer 13 free from the grooves 10 is reduced too much, and a portion of the surface between two adjacent grooves 10 is protruded, which is easily crushed. When the protruded portion is crushed by chucking the electrode in a transfer process, the thickness of the negative electrode active material layer 13 may disadvantageously vary.

On the other hand, when the pitch P of the grooves 10 exceeds 200 μm, the current collector core 12 stretches, and the negative electrode active material layer 13 is greatly stressed. Further, peel resistance of the active material on the current collector core 12 decreases, and the active material may easily fall from the current collector core 12.

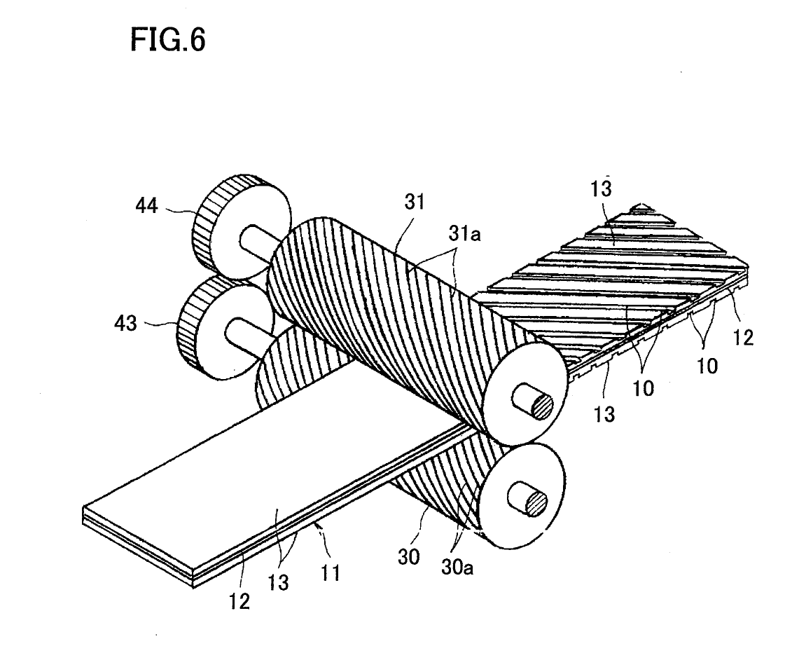

The decrease in peel resistance due to the increase in pitch P of the grooves 10 will be described in detail below. When the negative electrode hoop material 11 passes between groove forming rollers 31, 30 which are the same rollers (see FIG. 6), groove forming protrusions 31a, 30a of the groove forming rollers 31, 30 bite into the negative electrode active material layers 13 of the double-coated part 14, thereby simultaneously forming the grooves 10 in each of the negative electrode active material layers 13. In this case, loads of the groove forming protrusions 31a, 30a are simultaneously applied to, and are canceled at portions of the double-coated part 14 where the groove forming protrusions 31a, 30a overlap with each other with the double-coated part 14 interposed therebetween. That is, the loads are canceled only at the portions of the double-coated part 14 where the grooves 10 formed on the surfaces of the double-coated part 14 overlap with each other with the double-coated part 14 interposed therebetween. Except for these portions, the loads of the groove forming protrusions 31a, 30a are received only by the current collector core 12.

Thus, when the grooves 10 are formed in the surfaces of the double-coated part 14 at a large pitch P to extend in the directions crossing each other at right angles, portions to which the loads of the groove forming protrusions 31a, 30a are applied increase in length, thereby applying a large load to the current collector core 12. This stretches the current collector core 12, and the active material may flake from the negative electrode active material layer 13, or the active material may peel from the current collector core 12, thereby decreasing peel resistance of the negative electrode active material layer 13 on the current collector core 12.

In order to verify that the peel resistance decreases with the increase of the pitch P of the grooves 10, four types of negative electrodes 3 were formed, in which the depth D of the grooves 10 were fixed to 8 μm, and the pitch P of the grooves 10 was changed to 460 μm, 260 μm, 170 μm, and 80 μm. As a result of a peeling test of these negative electrodes 3, the peel resistance was about 4 N/m, about 4.5 N/m, about 5 N/m, and about 6 N/m in the descending order of the pitch P. This verifies that the peel resistance decreases with the increase of the pitch P of the grooves 10, and the active material easily falls.

After the grooves 10 are formed, cross-sections of the negative electrodes 3 were checked. In the negative electrode 3 provided with the grooves 10 at a large pitch P of 260 μm, the current collector core 12 was curved, and part of the active material was slightly peeled and separated from the current collector core 12. Thus, the pitch P of the grooves 10 is preferably set in the range of 100 μm to 200 μm, both inclusive.

The grooves 10 formed in one of the surfaces of the double-coated part 14, and the grooves 10 formed in the other surface of the double-coated part 14 extend in the directions crossing each other. Therefore, when the groove forming protrusions 31a, 30a bite into the negative electrode active material layers 13 on the surfaces of the double-coated part 14, warp in the negative electrode active material layer 13 on one surface, and warp in the negative electrode active material layer 13 on the other surface are advantageously canceled each other. Further, when the grooves 10 are formed in the corresponding surfaces at the same pitch, a distance between portions of the double-coated part 14 where the grooves 10 overlap with each other is the minimum, thereby reducing the load applied to the current collector core 12. This increases peel resistance of the active material on the current collector core 12, thereby effectively preventing the active material from falling.

The grooves 10 formed in one of the surfaces of the double-coated part 14 are arranged in a pattern having a phase symmetric with a phase of a pattern of the grooves 10 formed in the other surface of the double-coated part 14. Accordingly, the negative electrode active material layers 13 formed on the surfaces of the double-coated part 14 stretch in the same manner when the grooves 10 are formed, and the negative electrode active material layers 13 would not be warped even after the formation of the grooves 10. With the provision of the grooves 10 in each of the surfaces of the double-coated part 14, a larger amount of the electrolyte can uniformly be held as compared with the case where the grooves 10 are formed only in one of the surfaces of the double-coated part 14. This can ensure long cycle life.

The depth D of the grooves 10 will be described with reference to FIG. 5. The penetration of the electrolyte into the electrode group 1 (impregnation with the electrolyte) improves as the depth D of the grooves 10 increases. In order to verify this relationship, three types of negative electrodes 3 were formed, in which the grooves 10 were formed in the negative electrode active material layers 13 on each of the surfaces of the double-coated part 14 at a fixed pitch P of 170 μm, while the depth D was changed to 3 μm, 8 μm, and 25 μm. Then, three types of electrode groups 1 were formed by winding the negative electrode 3 and the positive electrode 2 with the separator 4 interposed therebetween. Each of the electrode groups 1 was placed in the battery case 7, and time required for the electrolyte to penetrate into the electrode group 1 was measured for comparison. As a result, the negative electrode 3 provided with the grooves 10 having a depth D of 3 μm required the penetration time of about 45 minutes, the negative electrode 3 provided with the grooves 10 having a depth D of 8 μm required the penetration time of about 23 minutes, and the negative electrode 3 provided with the grooves 10 having a depth D of 25 μm required the penetration time of about 15 minutes. This shows that the penetration of the electrolyte into the electrode group 1 improves as the depth D of the grooves 10 increases, and that the penetration of the electrolyte does not significantly improve when the depth D of the grooves 10 is smaller than 4 μm.

The penetration of the electrolyte improves as the depth D of the grooves 10 increases. However, the active material is severely compressed at portions where the grooves 10 are formed. Thus, lithium ions cannot move freely, and the lithium ions are less received. As a result, lithium metal may easily be deposited. Further, the negative electrode 3 is thickened as the depth D of the grooves 10 increases, and the stretch of the negative electrode 3 increases, thereby causing easy peeling of the active material from the current collector core 12. Further, the thickened negative electrode 3 may cause troubles in manufacture. For example, the active material may peel from the current collector core 12 in winding the electrodes to form the electrode group 1, or the electrode group 1 whose diameter is increased due to the increase in thickness of the negative electrode 3 may rub an end of an opening of the battery case 7 when the electrode group 1 is placed in the battery case 7, thereby making the placement of the electrode group 1 difficult. In addition, when the active material tends to easily peel from the current collector core 12, conductivity deteriorates, thereby affecting the battery characteristics.

The peel resistance of the active material on the current collector core 12 presumably decreases as the depth D of the grooves 10 increases. Specifically, the negative electrode active material layer 13 is thickened as the depth D of the grooves 10 increases. The increase in thickness results in decrease in peel resistance because a large force is applied in a direction of peeling the active material from the current collector core 12. In order to verify this relationship, four types of negative electrodes 3 were formed, in which the pitch P of the grooves 10 was fixed to 170 μm, and the depth D of the grooves 10 was changed to 25 μm, 12 μm, 8 μm, and 3 μm. As a result of a peeling test of these negative electrodes 3, the peel resistance was about 4 N/m, about 5 N/m, about 6 N/m, and about 7 N/m in the descending order of the depth D. This verifies that the peel resistance decreases as the depth D of the grooves 10 increases.

From the foregoing, the followings have been found with respect to the depth D of the grooves 10. Specifically, when the depth D of the grooves 10 is set smaller than 4 μm, the penetration of the electrolyte (the impregnation with the electrolyte) is insufficient. On the other hand, when the depth D of the grooves 10 exceeds 20 μm, the peel resistance of the active material on the current collector core 12 decreases. As a result, the battery capacity may decrease, or the fallen active material may penetrate the separator 4 to contact with the positive electrode 2, thereby causing an internal short circuit. Thus, when the depth D of the grooves 10 is reduced as much as possible, and the number of the grooves 10 is increased, the disadvantageous phenomena can be prevented from occurring, and good penetration of the electrolyte can be obtained. For these purposes, the depth D of the grooves 10 should be set in the range of 4 μm to 20 μm, both inclusive, preferably 5 to 15 μm, more preferably 6 to 10 μm.

In an example of the present embodiment, the pitch P of the grooves 10 is set to 170 μm, and the depth D of the grooves 10 is set to 8 μm. However, the pitch P may be set in the range of 100 μm to 200 μm, both inclusive. The depth D of the grooves 10 may be set in the range of 4 μm to 20 μm, both inclusive, preferably 5 to 15 μm, more preferably 6 to 10 μm. In order to verify the preferred ranges, three types of negative electrodes 3 were formed, i.e., a first negative electrode 3 including the grooves 10 having the depth D of 8 μm formed in each of the surfaces of the double-coated part 14 at the pitch P of 170 μm, a second negative electrode 3 including the grooves of the same depth D arranged at the same pitch P in only one of the surfaces of the double-coated part 14, and a third negative electrode 3 including no grooves 10 in the surfaces thereof. A plurality sets of batteries were produced by placing three types of electrode groups 1 constituted of these negative electrodes 3 in the battery cases 7. A predetermined amount of the electrolyte was injected in each of the battery cases, and the battery cases were evacuated to impregnate the electrode group with the electrolyte. Then, the batteries were disassembled to check the degree of impregnation of the negative electrode 3 with the electrolyte.

Immediately after the injection of the electrolyte, the negative electrode 3 including no grooves 10 in the surfaces thereof was impregnated with the electrolyte only by 60% of an area thereof. In the negative electrode 3 including the grooves 10 in only one of the surfaces thereof, 100% of an area of the surface provided with the grooves 10 was impregnated with the electrolyte, while about 80% of an area of the surface provided with no grooves 10 was impregnated with the electrolyte. Contrary to this, in the negative electrode 3 provided with the grooves 10 in each of the surfaces thereof, 100% of an area of each of the surfaces was impregnated with the electrolyte.

To check time required for impregnating the whole part of the negative electrode 3 with the electrolyte after the injection, the batteries were disassembled and checked every hour. As a result, in the negative electrode 3 provided with the grooves 10 in each of the surfaces thereof, 100% of each of the surfaces was impregnated with the electrolyte immediately after the injection. In the negative electrode 3 provided with the grooves 10 in only one of the surfaces thereof, 100% of the surface provided with no grooves 10 was impregnated with the electrolyte after a lapse of two hours. In the negative electrode 3 provided with no grooves 10 in the surfaces thereof, 100% of each of the surfaces was impregnated with the electrolyte after a lapse of five hours. However, in a portion of the negative electrode 3 impregnated immediately after the injection, the amount of the electrolyte was small, thereby varying the distribution of the electrolyte. The results indicate that the negative electrode 3 with the grooves 10 formed in each of the surfaces thereof can be impregnated with the electrolyte in about half the time required to completely impregnate the negative electrode 3 including the grooves 10 of the same depth D formed in only one of the surfaces thereof, and can increase the cycle life of the battery.

During the cycle test, the batteries were disassembled to examine the distribution of the electrolyte in the electrode provided with the grooves 10 in only one of the surfaces thereof for the purpose of examining the cycle life by checking the amount of EC (ethylene carbonate), which is a main ingredient of the nonaqueous electrolyte, extracted per unit area of the electrode. As a result, irrespective of a portion of the electrode where the extraction was performed, the surface provided with the grooves 10 contained EC in an amount larger by about 0.1 to 0.15 mg than the surface which was not provided with the grooves 10. Specifically, when the grooves 10 are formed in each of the surfaces, the EC amount in the surfaces of the electrode was the largest, and the surfaces were uniformly impregnated with the electrolyte without uneven distribution of the electrolyte. In the surface provided with no grooves 10, however, the amount of the electrolyte was small, thereby increasing internal resistance, and reducing the cycle life.

The grooves 10 are formed to extend from one lateral end to the other lateral end of the negative electrode active material layer 13. This can significantly improve the penetration of the electrolyte into the electrode group 1, thereby greatly reducing the penetration time. In addition, since the impregnation of the electrode group 1 with the electrolyte is significantly improved, depletion of the electrolyte for charge/discharge of the battery can effectively be prevented, and uneven distribution of the electrolyte in the electrode group 1 can be prevented. Further, with the grooves 10 inclined relative to the longitudinal direction of the negative electrode 3, the impregnation of the electrode group 1 with the electrolyte improves, and stress caused on the electrodes in the winding step for forming the electrode group 1 can be prevented, thereby effectively preventing break of the negative electrode 3.

A process of forming the grooves 10 in the surfaces of the double-coated part 14 will be described with reference to FIG. 6. As shown in FIG. 6, a pair of groove forming rollers 31, 30 are arranged to have a predetermined gap therebetween, and the negative electrode hoop material 11 shown in FIG. 2(a) is allowed to pass through the gap between the groove forming rollers 31, 30. In this manner, the grooves 10 of a predetermined shape are formed in the negative electrode active material layer 13 on each of the surfaces of the double-coated part 14 of the negative electrode hoop material 11.

The groove forming rollers 31, 30 are the same rollers, and each of which includes a plurality of groove forming protrusions 31a, 30a extending at a helix angle of 45° with respect to an axial center thereof Each of the groove forming protrusions 31a, 30a is easily and precisely formed by coating the entire surface of an iron roller body with chromium oxide by thermal spraying to form a ceramic layer, and partially melting the ceramic layer by laser application to form a predetermined pattern. The groove forming rollers 31, 30 are almost the same rollers as a laser-engraved ceramic roller generally used in the field of printing. The groove forming rollers 31, 30 made of chromium oxide have hardness of HV1150 or higher, i.e., they are considerably hard. Therefore, the rollers are resistant to sliding movement and wear, and are capable of ensuring life ten or more times longer than that of iron rollers. Thus, when the negative electrode hoop material 11 passes through the gap between the groove forming rollers 31, 30, each of which is provided with a number of groove forming protrusions 31a, 30a, the grooves 10 extending in the directions crossing each other at right angles can be formed in the negative electrode active material layer 13 on each of the surfaces of the double-coated part 14 of the negative electrode hoop material 11 as shown in FIG. 4.

Each of the groove forming protrusions 31a, 30a has a cross-sectional shape which allows formation of the grooves 10 having the cross-sectional shape shown in FIG. 5, i.e., an arc-shaped cross-sectional shape in which a tip end has an angle β of 120°, and a curvature R of 30 μm. The angle β at the tip end is set to 120° because the ceramic layer is easily broken when the angle is smaller than 120°. The curvature R at the tip end of the groove forming protrusions 31a, 30a is set to 30 μm to prevent the occurrence of crack in the negative electrode active material layers 13 when the grooves 10 are formed by pressing the groove forming protrusions 31a, 30a onto the negative electrode active material layers 13. The height of the groove forming protrusions 31a, 30a is set to about 20 to 30 μm because the most preferable depth D of the grooves 10 is in the range of 6 to 10 μm. If the groove forming protrusions 31a, 30a are too short, the flat surface of the groove forming roller 31, 30 around the groove forming protrusions 31a, 30a comes into contact with the negative electrode active material layer 13, and the active material separated from the negative electrode active material layer 13 is adhered to the surface around the groove forming rollers 31, 30. For this reason, the height of the protrusions has to be larger than the depth D of the grooves 10 to be formed.

For rotating the groove forming rollers 31, 30, rotary force applied by a servomotor etc. is transferred to the groove forming roller 30, and the rotation of the groove forming roller 30 is transferred to the groove forming roller 31 through a pair of gears 44, 43 which are attached to roller shafts of the groove forming rollers 31, 30, respectively, and engage with each other. Thus, the groove forming rollers 31, 30 rotate at the same rotational speed. As a process for forming the grooves 10 by biting the groove forming protrusions 31a, 30a of the groove forming roller 31, 30 into the negative electrode active material layer 13, there are two types of processes. One is a constant dimension process of setting the depth D of the grooves 10 by controlling the gap between the groove forming rollers 31, 30. The other is a constant pressure process in which the groove forming roller 30 to which the rotary force is transferred is fixed, and pressure applied to the groove forming roller 31 capable of moving up and down is adjusted in view of correlation between pressure applied to the groove forming protrusions 31a, 30a and the depth D of the grooves 10, thereby setting the depth D of the grooves 10. In the present invention, the grooves 10 are preferably formed by the constant pressure process.

A reason why the constant pressure process is preferable is as follows. In the constant dimension process, it is difficult to precisely set the gap between the groove forming rollers 31, 30 for setting the depth D of the grooves 10 in the order of μm. In addition, deflections of the roller shafts of the groove forming rollers 31, 30 directly affect the depth D of the grooves 10. In the constant pressure process, pressure for pressing the groove forming roller 31 (e.g., air pressure of an air cylinder) can automatically be adjusted to be constant even if the thickness of the double-coated part 14 varies, although it is slightly affected by the filling density of the active material in the negative electrode active material layer 13. Thus, the grooves 10 of the predetermined depth D can be formed with high productivity.

In forming the grooves 10 by the constant pressure process, the negative electrode hoop material 11 has to pass through the gap between the groove forming rollers 31, 30 without forming the grooves 10 in the negative electrode active material layer 13 of the single-coated part 17 of the negative electrode hoop material 11. In this case, a stopper can be provided between the groove forming rollers 31, 30 to keep the groove forming roller 31 in a non-pressing state with respect to the single-coated part 17. The “non-pressing state” indicates a state where the groove forming roller 31 abuts the single-coated part 17, but does not form the grooves 10 (a non-contact state is also included).

When the negative electrode 3 is thin, the double-coated part 14 is as thin as about 200 μm. In order to form the grooves 10 having a depth D of 8 μm in the thin double-coated part 14, the grooves 10 have to be formed with higher precision. For this purpose, each of the roller shafts of the groove forming rollers 31, 30 is fitted in bearings without leaving a gap therebetween, except for a gap which allows the bearings to rotate, and the bearings and bearing holders for holding the bearings are also fitted with each other without leaving a gap therebetween. Thus, the negative electrode hoop material 11 is allowed to pass through the gap between the groove forming rollers 31, 30 without wobbling. In this way, the negative electrode hoop material 11 is allowed to smoothly pass through the gap between the groove forming rollers 31, 30 in such a manner that the grooves 10 are precisely formed in the negative electrode active material layer 13 on each of the surfaces of the double-coated part 14, while the grooves 10 are not formed in the negative electrode active material layer 13 on the surface of the single-coated part 17.

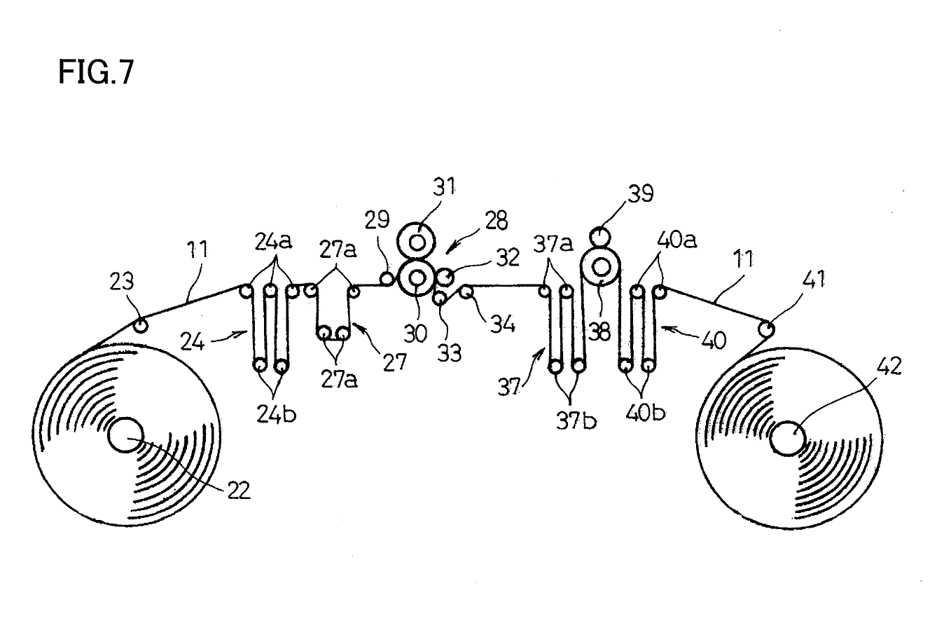

A method and an apparatus for producing the negative electrode for the battery will be described in detail with reference to FIG. 7. FIG. 7 schematically shows the general structure of an apparatus for producing the negative electrode for the battery of the present embodiment. As shown in FIG. 7, the negative electrode hoop material 11 wound about an uncoiler 22 is unwound from the uncoiler 22 while being guided by an uncoiler-side guide roller 23. Then, the negative electrode hoop material 11 sequentially passes through a feeding dancer roller mechanism 24 (a combination of three upper supporting rollers 24a and two lower dancer rollers 24b), and an anti-snaking roller mechanism 27 (including four rollers 27a arranged in a rectangular pattern), and is fed to a groove forming mechanism 28. The groove forming mechanism 28 includes a feeding-and-wrapping guide roller 29, a groove forming roller 30, a groove forming roller 31, an auxiliary drive roller 32, and an extracting- and-wrapping guide roller 33.

When the negative electrode hoop material 11 shown in FIG. 2(a) passes through the groove forming mechanism 28, the grooves 10 are formed only in the negative electrode active material layer 13 on each of the surfaces of the double-coated part 14 as shown in FIG. 2(b). The negative electrode hoop material 11 provided with the grooves runs on a direction changing guide roller 34, and is guided to an extracting dancer roller mechanism 37 (a combination of three upper supporting rollers 37a and two lower dancer rollers 37b). Then, the hoop material 11 passes between a secondary drive roller 38 and an auxiliary transfer roller 39, is fed to a winding-adjusting dancer roller mechanism 40 (a combination of three upper supporting rollers 40a and two lower dancer rollers 40b), and is wound about a coiler 42 through a coiler-side guide roller 41.

In each of the dancer roller mechanisms 24, 37, the supporting roller 24a, 37a is fixed, and the dancer roller 24b, 37b is able to move up and down. In response to change in tension applied to the negative electrode hoop material 11 being transferred, the dancer roller 24b, 37b automatically moves up and down, thereby keeping the tension applied to the negative electrode hoop material 11 constant. Thus, while the negative electrode hoop material 11 is held in the dancer roller mechanism 24, 37, the negative electrode hoop material 11 is always kept at the predetermined tension. Therefore, in the groove forming mechanism 28, the negative electrode hoop material 11 can be transferred at the predetermined transfer speed by applying only a small transfer force thereto.

The tension applied to the negative electrode hoop material 11 in the groove forming mechanism 28, and the tension applied to the negative electrode hoop material 11 on the coiler 42 are set separately. Further, the rotational speed of the secondary drive roller 38, and the position of the dancer roller 40b of the winding-adjusting dancer roller mechanism 40 are automatically adjusted in such a manner that the negative electrode hoop material 11 is wound about the coiler 42 tightly at the beginning, and then loosely as the diameter of the wound hoop material increases. Thus, the negative electrode hoop material 11 provided with the grooves 10 is appropriately wound about the coiler 42 without misalignment.

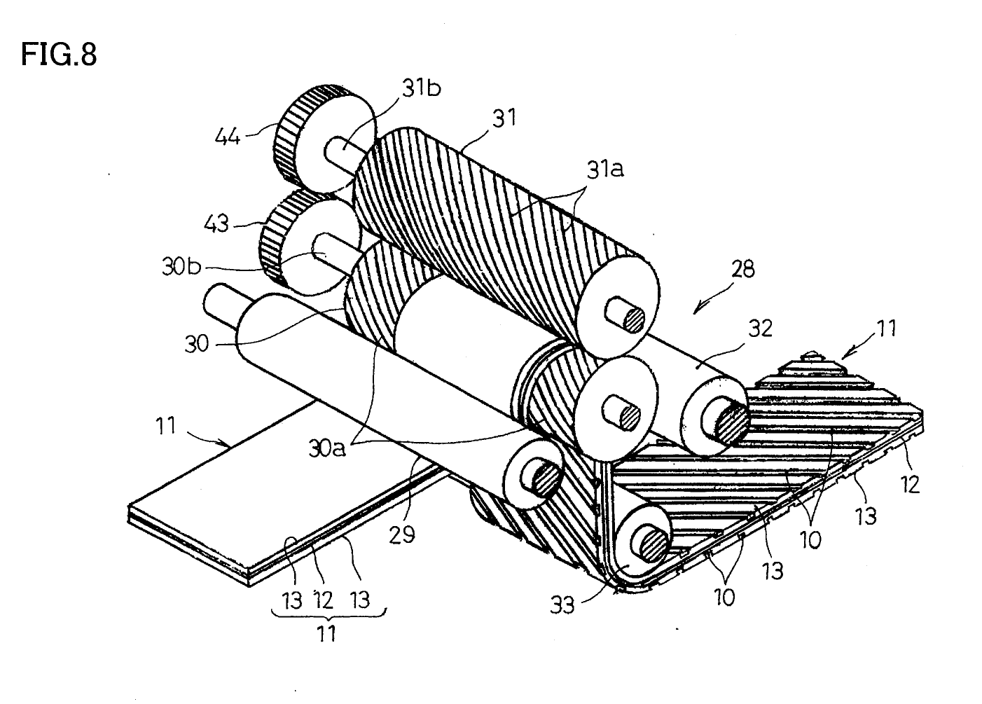

FIG. 8 is an enlarged perspective view illustrating the structure of the groove forming mechanism 28 shown in FIG. 7. The groove forming rollers 30, 31 are the same rollers, and each of which is provided with a plurality of groove forming protrusions 30a, 31a arranged at a helix angle of 45° relative to the axial center of the roller. The groove forming rollers 30, 31 are aligned in the vertical direction, and the negative electrode hoop material 11 is allowed to pass through the gap therebetween. Then, as shown in FIG. 4, the grooves 10 are formed in each of the negative electrode active material layers 13 on the surfaces of the double-coated part 14 of the negative electrode hoop material 11 in such a manner that the grooves 10 formed in one of the surfaces, and the grooves 10 formed in the other surface extend in directions crossing each other at right angles.

The groove forming roller 30 is fixed, while the groove forming roller 31 is able to move up and down in a small, predetermined movement range. For rotating the groove forming rollers 31, 30, rotary force applied by a servomotor etc. is transferred to the groove forming roller 30, and the rotation of the groove forming roller 30 is transferred to the groove forming roller 31 through engagement between a pair of gears 43, 44 which are attached to the roller shafts of the groove forming rollers 31, 30, respectively, and engage with each other. Thus, the groove forming rollers 30, 31 rotate at the same rotational speed.

The feeding-and-wrapping guide roller 29 and the extracting-and-wrapping guide roller 33 are arranged relative to each other in such a manner that the guide rollers can wrap the negative electrode hoop material 11 about almost half the circumference of the groove forming roller 30. A flat auxiliary drive roller 32 which is not provided with the groove forming protrusions is arranged at a position where the negative electrode hoop material 11 passes before passing the extracting-and-wrapping guide roller 33, and presses the negative electrode hoop material 11 onto the groove forming roller 30 with a small pressure. The auxiliary drive roller 32 presses a portion of the negative electrode hoop material 11 which is wrapped around the groove forming roller 30 by the extracting-and-wrapping guide roller 33.

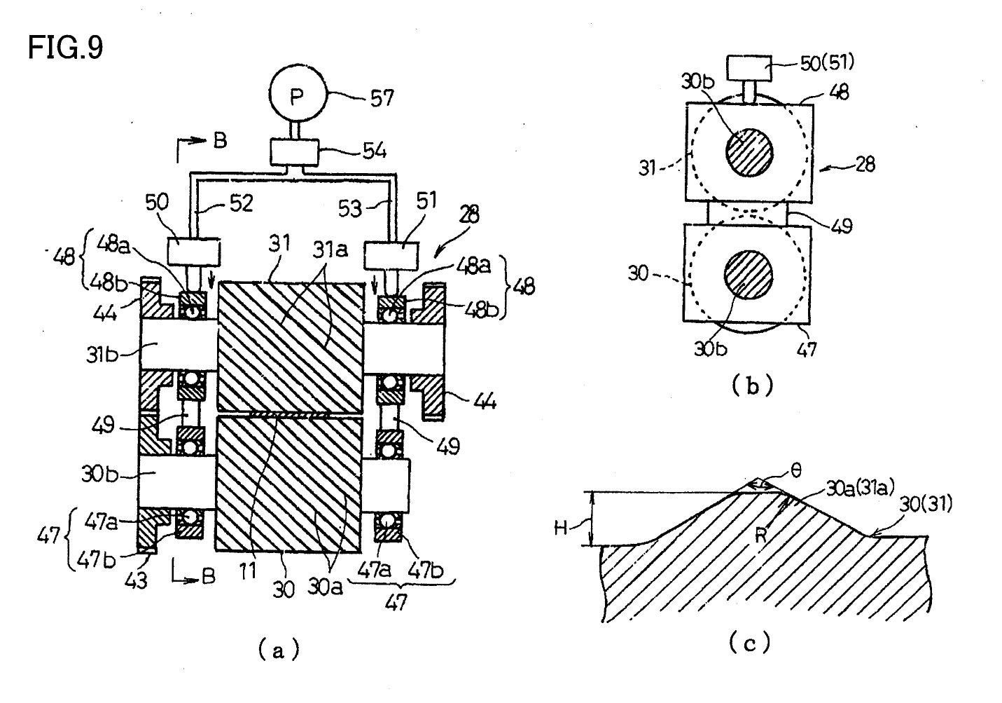

FIGS. 9(a) to 9(c) show the groove forming rollers 30, 31 with the single-coated part 17 of the negative electrode hoop material 11 passing through the gap between the groove forming rollers 30, 31. FIG. 9(a) is a vertical cross-sectional view taken along the line passing the centers of the groove forming rollers 30, 31, and FIG. 9(b) is a cross-sectional view taken along the line B-B shown in FIG. 9(a). Each of the roller shafts 30b, 31b of the groove forming rollers 30, 31 is rotatably supported by a pair of ball bearings 47, 48 arranged near the ends of the roller shaft, respectively. Each of the roller shafts 30b, 31b of the groove forming rollers 30, 31 is press-fitted in the ball bearings 47, 48 without leaving a gap therebetween, except for a gap which allows the ball bearings 47, 48 to rotate. Each of the ball bearings 47, 48 includes balls 47a, 48a which are press-fitted in a bearing holder 47b, 48b without leaving a gap therebetween.

For forming the grooves 10 by the constant pressure process, the negative electrode hoop material 11 has to pass through the gap between the groove forming rollers 30, 31 without forming the grooves 10 in the single-coated part 17 of the negative electrode hoop material 11. For this purpose, a stopper (a gap adjuster) 49 is provided between the groove forming rollers 30, 31. The stopper 49 functions to prevent the groove forming roller 31 from approaching the groove forming roller 30 beyond the minimum gap between the groove forming rollers 30, 31 which is provided not to form the grooves 10 in the single-coated part 17. Thus, the negative electrode hoop material 11 is allowed to pass between the groove forming rollers 30, 31 without forming the grooves 10 in the single-coated part 17.

When the negative electrode 3 is thin, the double-coated part 14 is as thin as about 120 μm. Accordingly, the grooves 10 having a depth D of 8 μm have to be precisely formed in the thin double-coated part 14 within a tolerance of ±1 μm. For this purpose, the roller shaft 30b, 31b is fitted in the ball bearings 47, 48 without leaving any tolerance gap therebetween, and the balls 47a, 48a are fitted in the bearing holder 47b, 48b of the ball bearing 47, 48 without leaving any tolerance gap therebetween, except for the gap which is required to rotate the balls 47a, 48a of the ball bearing 47, 48. Thus, the wobbling of the groove forming rollers 30, 31 is prevented.

In addition, the groove forming mechanism 28 includes the following groove forming mechanism for precisely forming the grooves 10 by the constant pressure process. Specifically, the groove forming roller 31 is configured in such a manner that two portions of the roller shaft 31b symmetric with respect to a body of the groove forming roller 31 receive pressures applied by air cylinders 50, 51, respectively. Air pipes 52, 53 for supplying the air to the air cylinders 50, 51 are branched from the same air path, and have the same pipe length, thereby always applying the same pressure to the two portions of the roller shaft 31b. A precise decompression valve 54 is provided at the branch point between the air pipes 52, 53. The precise decompression valve (a pressure adjuster) 54 always keeps pressure of the air supplied from an air pump 57 at the set value, and supplies the air to the air cylinders 50, 51.

Specifically, in the double-coated part 14 of the negative electrode hoop material 11, each of the negative electrode active material layers 13 is pressed by rolling to have a generally uniform thickness. However, the thickness still varies in the range of 1 to 2 μm. When the pressure of the air cylinders 50, 51 starts to increase due to the variation in thickness of the double-coated part 14, the precise decompression valve 54 automatically discharges extra air to keep the predetermined pressure. Thus, the air pressure of each of the air cylinders 50, 51 is automatically adjusted to the predetermined pressure, irrespective of the thickness variation of the double-coated part 14. Therefore, the groove forming protrusions 30a, 31a of the groove forming rollers 30, 31 bite into the negative electrode active material layers 13 uniformly at any time, irrespective of the thickness variation of the double-coated part 14, thereby allowing precise formation of the grooves 10 of the predetermined depth D. The air cylinders 50, 51 may be replaced with hydraulic cylinders, or servomotors.

The groove forming roller 31 is configured to receive the rotary force of the groove forming roller 30 through the engagement between the gears 44, 43 at only one of the ends of the roller shaft 31b. However, the roller shaft 31b includes an additional gear 44 at the other end thereof having the same weight as the gear 44 at the one end thereof. The gear 44 on the other end of the roller shaft functions as a balancer. Therefore, the gear 44 on the other end may be replaced with a round balancer. Thus, the groove forming roller 31 applies the pressure to the negative electrode hoop material 11 uniformly in the lateral direction of the negative electrode hoop material 11.

FIG. 9(c) is a cross-sectional view illustrating a portion of the groove forming roller 30, 31 where the groove forming protrusion 30a, 31a is formed. Each of the groove forming protrusions 30a, 31a has a cross-sectional shape which allows formation of the grooves 10 having the cross-sectional shape shown in FIG. 5, i.e., an arc-shaped cross-sectional shape in which a tip end thereof has an angle θ of 120°, and a curvature R of 30 μm. With the angle θ at the tip end set to 120°, the ceramic layer formed on the surface of an iron roller body would not break. Further, with the curvature R of the groove forming protrusions 30a, 31a set to 30 μm, the occurrence of crack in the negative electrode active material layer 13 is prevented when the grooves 10 are formed by pressing the groove forming protrusions 30a, 31a onto the negative electrode active material layers 13.

As described above, the groove forming protrusions 30a, 31a are formed by coating the entire surface of an iron roller body with chromium oxide by thermal spraying to form a ceramic layer, and partially melting the ceramic layer by laser application to form a predetermined pattern. Thus, the groove forming protrusions 30a, 31a of the above-described pattern can be formed with high precision. In this formation process, each of the groove forming protrusions 30a, 31a is precisely provided with the arc-shaped tip end having a curvature R of 30 μm as described above. In addition, a proximal portion of the groove forming protrusions 30a, 31a is inevitably arc-shaped. In other words, sharp corners are not provided. This also reduces the possibility of break of the ceramic layer on the surface of the groove forming rollers 30, 31.

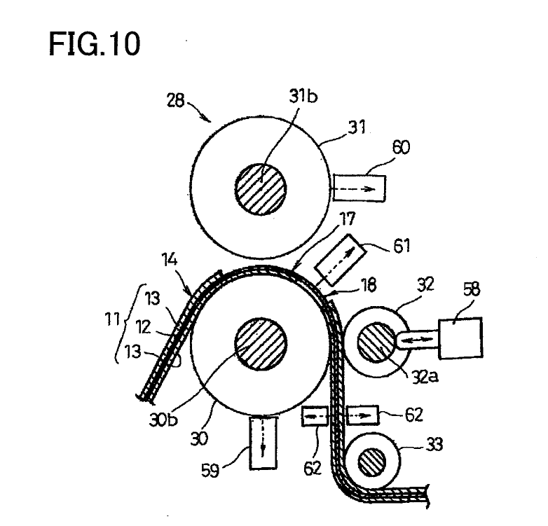

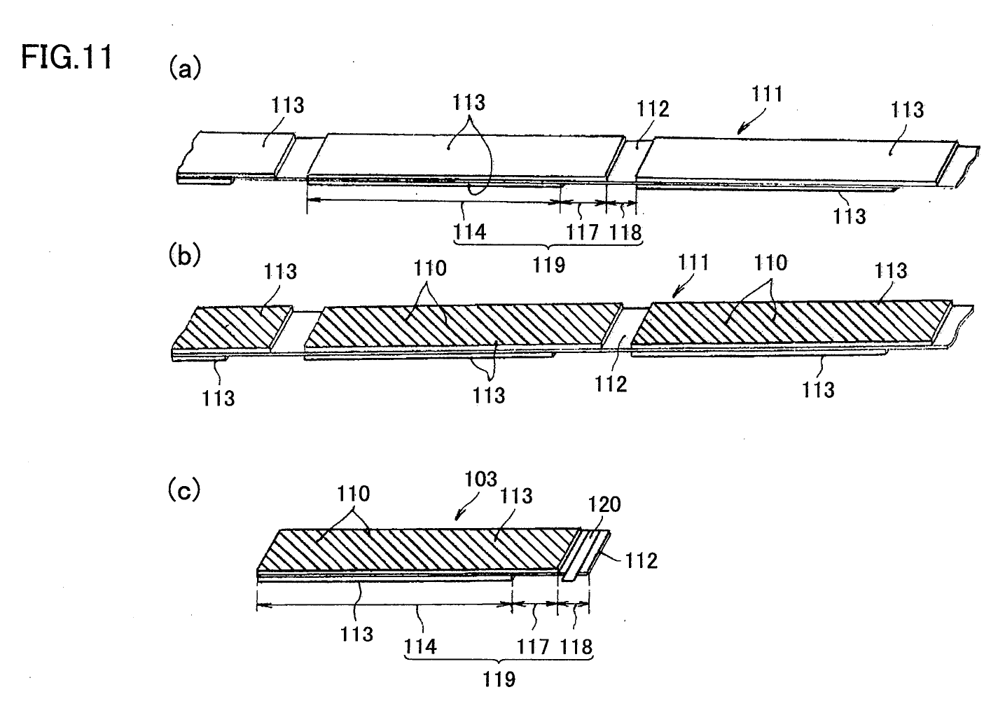

FIG. 10 is a side view illustrating the groove forming mechanism 28. The auxiliary drive roller 32 is made of silicone rubber having hardness of about 80 degrees, and is configured to be able to move in the horizontal direction by a predetermined distance so as to contact or separate from the groove forming roller 30. The auxiliary drive roller 32 is a free roller to which drive force is not applied. A roller shaft 32a thereof is pressed by an auxiliary transfer force-applying air cylinder 58, thereby pressing the negative electrode hoop material 11 having the grooves 10 formed in the double-coated part 14 onto the groove forming roller 30. A load applied to the negative electrode hoop material 11 by the auxiliary drive roller 32 is adjusted to be constant at any time by the air pressure of the auxiliary transfer force-applying air cylinder 58. Specifically, when the single-coated part 17 of the negative electrode hoop material 11 passes between the groove forming roller 30 and the auxiliary drive roller 32, the air pressure of the auxiliary transfer force-applying air cylinder 58 is automatically adjusted in such a manner that the auxiliary drive roller 32 always receives a load which does not allow the formation of the grooves 10 in the negative electrode active material layer 13 on the single-coated part 17 by the groove forming protrusions 30a of the groove forming roller 30.

As shown in FIG. 9, the negative electrode hoop material 11 is supposed to pass between the groove forming rollers 30, 31 with the negative electrode active material layer 13 of the single-coated part 17 facing the groove forming roller 30. Thus, when the single-coated part 17 of the negative electrode hoop material 11 passes through the gap between the groove forming rollers 30, 31, the stopper 49 can prevent the groove forming roller 31 from pressing the single-coated part 17. If the negative electrode hoop material 11 is transferred with the negative electrode active material layer 13 of the single-coated part 17 facing the groove forming roller 31, a component for pressing the groove forming roller 31 upward to be separated from the negative electrode active material layer 13 of the single-coated part 17 is required in place of the stopper 49 so as not to form the grooves 10 in the negative electrode active material layer 13 of the single-coated part 17. This makes it difficult to allow the groove forming roller 31 to smoothly move up and down.

Dust collecting nozzles 59, 60 for cleaning the roller surfaces by sucking the active material adhered to the roller surfaces are arranged near the surfaces of the groove forming rollers 30, 31, respectively. A gap of about 2 mm is provided between the ends of the dust collecting nozzles 59, 60 and the roller surfaces. A dust collecting nozzle 61 is arranged between the gap between the groove forming rollers 30, 31 and the auxiliary drive roller 32 for the purpose of cleaning the negative electrode hoop material 11 by sucking the active material adhered to the negative electrode hoop material 11 immediately after the formation of the grooves 10 by the groove forming rollers 30, 31. Further, a pair of dust collecting nozzles 62 are arranged to face the surfaces of the negative electrode hoop material 11 between the auxiliary drive roller 32 and the extracting-and-wrapping guide roller 33, respectively. The dust collecting nozzles 59 to 62 suck the air at a suction velocity of 10 m/sec or higher.

A method for producing the negative electrode for the battery according to the present embodiment will be described below. First, as shown in FIG. 2(a), the negative electrode hoop material 11 including the double-coated part 14, the single-coated part 17, and the core exposed part 18 is formed by an intermittent application process. The negative electrode hoop material 11 is allowed to pass through the gap between the groove forming rollers 30, 31 of the groove forming mechanism 28, thereby forming the grooves 10 in each of the surfaces of the double-coated part 14 of the negative electrode hoop material 11. In the groove forming mechanism 28, the precise decompression valve 54, which adjusts the air pressures supplied to the pair of air cylinders 50, 51 through the air pipes 52, 53 of the same length, automatically and precisely adjusts the air pressures of the pair of air cylinders 50, 51 to a set value at any time to absorb the thickness variation of the double-coated part 14. Thus, the groove forming roller 31 is kept pressed onto the double-coated part 14 at a constant pressure. Specifically, the groove forming rollers 30, 31 transfer the negative electrode hoop material 11 while sandwiching the double-coated part 14 at the predetermined pressure by the constant pressure process, thereby forming the grooves 10 in each of the surfaces of the double-coated part 14. In this way, the groove forming protrusions 30a, 31a of the groove forming rollers 30, 31 reliably form the grooves 10 having the constant, predetermined depth D of 8 μm in the negative electrode active material layers 13, irrespective of the thickness variation of the double-coated part 14.

The groove forming rollers 30, 31 are rotatably supported by the ball bearings 47, 48 without any tolerance gap, thereby preventing the wobbling of the rollers. Further, since the negative electrode hoop material 11 is transferred while being wound around almost half the circumference of the groove forming roller 30, the wobbling is prevented even if the tension applied to the negative electrode hoop material 11 is small. Thus, the groove forming roller 31 always receives the set pressure from the air cylinders 50, 51, and the grooves 10 having the depth D of 8 μm with a tolerance of ±1 μm can precisely be formed in the double-coated part 14 of the negative electrode hoop material 11. Further, when the single-coated part 17 passes between the groove forming rollers 30, 31, falling of the active material from the negative electrode active material layer 13 of the single-coated part 17 due to the wobbling would not occur.

The groove forming roller 31 has to smoothly move up and down in accordance with the thickness variation of the double-coated part 14 of the negative electrode hoop material 11. In this case, when the gap between the groove forming roller 31 moved to the top position and the groove forming roller 30 is too large, reproducibility is not provided. Therefore, the range of the vertical movement of the groove forming roller 31 has to be set in view of the reproducibility. In the case where the grooves 10 having the depth D of 8 μm are formed in the negative electrode active material layer 13 on each of the surfaces of the double-coated part 14 of about 200 μm in thickness, the gap between the groove forming rollers 30, 31 has to be set in consideration of a gap which allows the ball bearings 47, 48 to rotate, and buckling of the negative electrode hoop material 11. Further, the groove forming protrusions 30a, 31a have to bite into the corresponding negative electrode active material layer 13 by a required depth or more. Therefore, in practical use, the gap between the groove forming rollers 30, 31 is adjusted.

The negative electrode hoop material 11 is controlled to reliably pass through the center of the gap between the groove forming rollers 30, 31 by the anti-snaking roller mechanism 27 shown in FIG. 7. Further, the groove forming roller 31 is configured to apply a laterally uniform pressure to the negative electrode hoop material 11 by the gears 44 of the same weight arranged at the ends of the groove forming roller 31, respectively. Thus, the grooves 10 having the laterally uniform depth D are formed in the double-coated part 14 of the negative electrode hoop material 11. When the single-coated part 17 of the negative electrode hoop material 11 passes through the gap between the groove forming rollers 30, 31, the groove forming roller 31 abuts a pair of stoppers 49 arranged at both ends of the roller to prevent the groove forming roller 31 from approaching the groove forming roller 30. Thus, the groove forming roller 31 is kept separated from the negative electrode hoop material 11 as shown in FIG. 10. Therefore, the negative electrode active material layer 13 of the single-coated part 17 passes through the gap without being pressed by the groove forming roller 30, and the grooves 10 are not formed therein. In this case, a minimum gap between the groove forming rollers 30, 31 is set as a gap which allows the ball bearings 47, 48 to rotate without forming the grooves 10 in the negative electrode active material layer 13 of the single-coated part 17.

In the present embodiment, the gap between the groove forming rollers 30, 31 through which the double-coated part 14 passes is set by the air pressures of the air cylinders 50, 51. At a point of time when the single-coated part 17 enters the gap between the groove forming rollers 30, 31, the groove forming roller 31 moves to abut the stoppers 49, and stops with a gap remaining between the groove forming rollers 30, 31. Since this gap is larger than the thickness of the single-coated part 17, the groove forming roller 30 will not form the grooves 10 in the negative electrode active material layer 13 of the single-coated part 17.

In this case, as shown in FIG. 10, transfer force applied to the negative electrode hoop material 11 by the groove forming rollers 30, 31 sandwiching the negative electrode hoop material 11 is released. However, the transfer force is applied to the negative electrode hoop material 11 by the groove forming roller 30 and the auxiliary drive roller 32 sandwiching the negative electrode hoop material 11. The auxiliary drive roller 32 is pressed onto the negative electrode hoop material 11 with a small pressure not to crush the grooves 10 formed in the double-coated part 14. Further, a constant tension is kept applied to the negative electrode hoop material 11 between the feeding dancer roller mechanism 24 and the extracting dancer roller mechanism 37. Therefore, the negative electrode hoop material 11 to which a constant tension is applied can reliably be transferred at the predetermined transfer speed, and at the constant tension only by applying a small transfer force derived from the small pressure applied by the auxiliary drive roller (a transfer force applying section) 32 to the negative electrode hoop material 11.

Specifically, when the single-coated part 17 and the core exposed part 18 of the negative electrode hoop material 11 reach the gap between the groove forming rollers 30, 31, and the groove forming rollers 30, 31 no longer sandwich the negative electrode hoop material 11, thereby releasing the transfer force applied to the negative electrode hoop material 11, the negative electrode hoop material 11 would not be transferred at unexpectedly high speed due to the tension applied thereto. Thus, the negative electrode hoop material 11 is transferred between the groove forming rollers 30, 31 without being loosened at any time, and is not stretched due to the application of high tension. As shown in FIG. 10, the auxiliary drive roller 32 is kept in contact with the double-coated part 14 while the core exposed part 18 and the single-coated part 17 of the negative electrode hoop material 11 pass through the gap between the groove forming rollers 30, 31. Then, the auxiliary transfer force-applying air cylinder 58 automatically adjusts the air pressure to apply a small pressure to the auxiliary drive roller 32 in such a manner that the auxiliary drive roller 32 does not crush the grooves 10 formed in the double-coated part 14.

As shown in FIGS. 8 and 10, the negative electrode hoop material 11 is transferred while being wrapped around almost half the circumference of the groove forming roller 30 by the feeding-and-wrapping guide roller 29 and the extracting-and-wrapping guide roller 33. This can effectively reduce flutter of the negative electrode hoop material 11 during the transfer, thereby preventing the active material from falling from the negative electrode active material layer 13 due to the flatter. Although the transfer speed has been about 5 m/sec in the conventional technique, the present embodiment makes it possible to transfer the hoop material quickly and stably at a transfer speed of about 30 to 50 m/sec, thereby allowing production of the negative electrode 3 with high productivity. As shown in FIG. 10, when forming the grooves 10 in the negative electrode hoop material 11 by sandwiching the negative electrode hoop material 11 between the groove forming rollers 30, 31, chips of the active material flaked from the negative electrode active material layer 13, and adhered to the circumferences of the groove forming rollers 30, 31 are sucked and removed by the dust collecting nozzles 59, 60. Further, chips of the active material adhered to the negative electrode hoop material 11 after the formation of the grooves 10 are also sucked and removed by the dust collecting nozzles 61, 62. This allows the formation of the grooves 10 in the negative electrode hoop material 11 with high reproducibility.

The present invention has been described by way of the preferred embodiment. However, the embodiment described above is not intended to limit the invention, and can be modified in various ways.

The negative electrode for the battery according to the embodiment of the invention, and a method and an apparatus for producing a cylindrical nonaqueous secondary battery using the negative electrode will be described in detail with reference to the drawings. The invention is not limited to the example.

### Example 1

A negative electrode mixture paste was prepared by mixing, in a kneader, 100 parts by weight of artificial graphite as a negative electrode active material, 2.5 parts by weight of styrene-butadiene copolymer rubber particle dispersion (40 wt % of solid content) as a binder relative to 100 parts by weight of the active material (1 part by weight on a basis of solid content of the binder), 1 part by weight of carboxymethyl cellulose as a thickener relative to 100 parts by weight of the active material, and a proper amount of water. The negative electrode mixture paste was applied to a current collector core 12 made of 10 μm thick copper foil, and the paste was dried and pressed by rolling to a total thickness of about 200 μm. Then, the obtained product was cut by a slitter into strips of about 60 mm in width, which is the width of a negative electrode 3 of a cylindrical lithium secondary battery having a nominal capacity of 2550 mAh, a diameter of 18 mm, and a height of 65 mm. Thus, a negative electrode hoop material 11 was formed. The obtained product was wound about an uncoiler 22 shown in FIG. 7.

Then, as groove forming rollers 30, 31, rollers of 100 mm in outer diameter were used, each of which was provided with groove forming protrusions 30a, 31a on a ceramic outer circumferential surface thereof. The groove forming protrusions 30a, 31a had an angle θ of 120° at a tip end thereof, and a height H of 25 μm, and were arranged at a pitch of 170 μm, while forming a helix angle of 45° with the circumferential direction of the roller. The negative electrode hoop material 11 was allowed to pass between the groove forming rollers 30, 31, thereby forming grooves 10 in each of the surfaces of the double-coated part 14 of the negative electrode hoop material 11. A groove forming mechanism 28 was configured to allow gears 43, 44 fixed to roller shafts 30b, 31b of the groove forming rollers 30, 31 to engage with each other, and to drive the groove forming roller 31 to rotate by a servomotor, thereby rotating the groove forming rollers 30, 31 at the same rotational speed.

Stoppers 49 were interposed between the groove forming rollers 30, 31 to prevent the rollers from approaching each other to have a gap of 100 μm or smaller therebetween. Whether the gap between the groove forming rollers 30, 31 was properly provided or not was checked, and air pressure of air cylinders 50, 51 for applying pressure to the groove forming roller 31 was adjusted to impose a load of 30 kgf per 1 cm of the width of the negative electrode hoop material 11. The air pressure was adjusted by a precise decompression valve 54. An auxiliary drive roller 32 was configured to have a surface made of silicone having hardness of about 80 degrees, and air pressure of an auxiliary transfer force-applying air cylinder 58 which presses the auxiliary drive roller 32 was adjusted to impose a load of about 2 kgf per 1 cm of the width of the negative electrode hoop material 11. The negative electrode hoop material 11 was transferred at the predetermined speed with a tension of several kg applied thereto. With this configuration, the grooves 10 were formed in each of the surfaces of the double-coated part 14 of the negative electrode hoop material 11. A depth D of the grooves 10 in the negative electrode active material layer 13 was measured by a profile measuring instrument. An average depth was 8.5 μm, and the grooves 10 were not formed in the negative electrode active material layer 13 of the single-coated part 17. Whether crack was formed in the negative electrode active material layer 13 or not was checked by a laser microscope, but the crack was not found at all. The negative electrode 3 increased in thickness by about 0.5 μm, and stretched in the longitudinal direction by about 0.1% per cell.

As a positive electrode active material, lithium nickel composite oxide represented by the composition formula of LiNi_{0.8}Co_{0.15}Al_{0.05}O₂ was used. To a NiSO₄ aqueous solution, cobalt sulfate and aluminum sulfate of the predetermined ratio were added to prepare a saturated aqueous solution. While stirring the saturated aqueous solution, an alkaline solution dissolving sodium hydroxide was slowly dropped therein for neutralization, thereby precipitating ternary system nickel hydroxide Ni_{0.8}Co_{0.15}Al_{0.05}(OH)₂. The precipitate was filtered, washed with water, and dried at 80° C. Nickel hydroxide obtained in this manner had an average particle diameter of about 10 μm.

Lithium hydroxide hydrate was added in such a manner the ratio between the sum of numbers of atoms of Ni, Co, and Al and the number of atoms of Li was 1:1.03, and the obtained product was thermally treated in an oxygen atmosphere for 10 hours at 800° C. to obtain LiNi_{0.8}Co_{0.15}Al_{0.05}O₂. As a result of powder X-ray diffractometry, the obtained lithium nickel composite oxide had a single phase, hexagonal crystalline structure, in which Co and Al were in the state of solid solution. The obtained product was pulverized, and classified to obtain positive electrode active material powder.

To 100 parts by mass of the active material, 5 parts by mass of acetylene black was added as a conductive agent, and a solution prepared by dissolving PVdF (polyvinylidene fluoride) as a binder in a NMP (N-methyl pyrrolidone) solvent was kneaded with the mixture to prepare paste. The amount of PVdF added was adjusted to 5 parts by mass relative to 100 parts by mass of the active material. The paste was applied to each surface of a current collector core made of 15 μm thick aluminum foil, and the paste was dried and rolled to obtain a positive electrode hoop material having a thickness of about 200 μm, and a width of about 60 mm.

After the negative and positive electrode hoop materials were dried to remove extra moisture, the electrode hoop materials were wound with a separator 4 made of an about 30 μm thick microporous polyethylene film interposed therebetween in a dry air room to form an electrode group 1. The negative electrode hoop material 11 is cut at the core exposed part 18 located between the double-coated part 14 and the single-coated part 17. Since the groove forming rollers 30, 31 are configured not to form the grooves 10 in the negative electrode active material layer 13 of the single-coated part 17, the core exposed part 18 and the single-coated part 17 were not deformed after the cutting, and operation of a winding machine was not affected. A current collector lead 20 was attached to the negative electrode hoop material 11 before the winding using a welder attached to the winding machine.

As a comparative example, the groove forming roller 30 was replaced with a flat roller not including the groove forming protrusions. Then, the gap between the groove forming rollers 31 and 30 was set to 100 μm, a load applied to the negative electrode 3 per 1 cm of the width was adjusted to 31 kg, and the grooves 10 having a depth D of about 8 μm were formed only in one of the negative electrode active material layers 13 of the double-coated part 14 to form a negative electrode (Comparative Example 1). Another negative electrode (Comparative Example 2) was formed without forming the grooves 10 in each of the negative electrode active material layers 13 of the double-coated part 14.

Each of the electrode group 1 prepared in this manner were placed in a battery case 7, and an electrolyte was injected in the battery case to examine penetration of the electrolyte. For evaluation of the penetration of the electrolyte, about 5 g of the electrolyte was fed into the battery case, and the battery case was evacuated to allow impregnation with the electrolyte. The electrolyte may be fed into the battery case in several times. After the predetermined amount of the electrolyte was injected, the battery case was placed in a vacuum booth for evacuation, thereby discharging air in the electrode group. Then, atmospheric air was introduced in the vacuum booth to forcibly allow the electrolyte to penetrate into the electrode group due to differential pressure between the pressure in the battery case and the pressure of the atmospheric air. The evacuation was performed by vacuum suction to a degree of vacuum of −85 kpa. Time required for the penetration was measured as data for comparison of the penetration.

In an actual battery production process, the electrolyte is simultaneously fed to a plurality of battery cases, and the battery cases are simultaneously deaerated by evacuation to a degree of vacuum of −85 kpa, and then the atmospheric air is introduced to forcibly allow the electrolyte to penetrate into the electrode group. Thus, the penetration of the electrolyte is finished. A determination of completion of the penetration is made when the electrolyte is no longer found when the inside of the battery case is visually checked from immediately above the battery case. To obtain average penetration time which could be used for actual production, the electrolyte is simultaneously allowed to penetrate into multiple cells. Table 1 shows the results.

TABLE 1

| | | | Penetration |
|---|---|---|---|
| | In electrode | In electrode group | time |
| Example 1 | Grooves are formed in each of | Grooves are formed in inner | 22 min. + |
| | the surfaces of the double- | and outer circumferential | 17 sec. |
| | coated part, but not formed in | surfaces | |
| | the single-coated part | | |
| Comparative | Grooves are formed in one of | Grooves are formed in an inner | — |
| Example 1 | the surfaces of the double- | circumferential surface | |
| | coated part, and in the single- | | |
| | coated part | | |
| Comparative | Grooves are not formed | Grooves are not formed | 69 min. + |
| Example 2 | | | 13 sec. |

As apparent from the results shown in Table 1, with use of the negative electrode (Example 1) in which the grooves 10 were formed in the negative electrode active material layer 13 on each surface of the double-coated part 14, the penetration of the electrolyte was significantly improved as compared with the negative electrode (Comparative Example 2) in which the grooves 10 were not formed in any of the negative electrode active material layers 13.

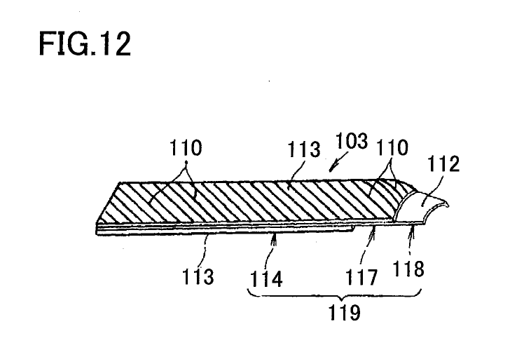

With use of the negative electrode (Comparative Example 1) in which the grooves 10 were formed in one of the negative electrode active material layers 13 of the double-coated part 14, and in the negative electrode active material layer 13 of the single-coated part 17, the electrodes were misaligned in the winding, and the active material fell from the negative electrode active material layer 13 of the single-coated part 17. Therefore, the check of the penetration was stopped. As a possible cause of these disadvantages, when the negative electrode hoop material 11 was cut at the core exposed part 18 adjacent to the double-coated part 14, the single-coated part 17 was warped as shown in FIG. 12 due to distribution of internal stress generated by forming the grooves 10 in the single-coated part 17. The deformation of the electrode caused misalignment in winding the electrodes, and failure in reliably holding the electrode by a chuck etc. As a result, the active material fell. With use of the negative electrode (Comparative Example 1) that caused the winding misalignment and the falling of the active material, the penetration time was 30 minutes.

For producing test batteries, the predetermined amount of the electrolyte was injected, evacuation was performed, and the atmospheric air was introduced for the penetration of the electrolyte into the electrode group. The battery of Example showed reduction of the penetration time. Therefore, the electrolyte was less evaporated during the penetration, thereby improving the penetration, and significantly reducing the penetration time. As a result, the opening of the battery case can hermetically be sealed while reducing the amount of the electrolyte evaporated as much as possible. This indicates that the improvement in penetration or impregnation of the electrolyte was able to greatly reduce the loss of the electrolyte.

### INDUSTRIAL APPLICABILITY

A negative electrode for a battery of the present invention, and an electrode group including the negative electrode allow good impregnation with an electrolyte, and has high productivity and reliability. A cylindrical nonaqueous secondary battery including the electrode group is useful for, e.g., driving power supplies for mobile electronic devices and communication devices.

### DESCRIPTION OF REFERENCE CHARACTERS

1 Electrode group
2 Positive electrode
3 Negative electrode
4 Separator
7 Battery case
8 Gasket
9 Sealing plate
10 Groove
11 Negative electrode hoop material
12 Current collector core
13 Negative electrode active material layer
14 Double-coated part
17 Single-coated part
18 Core exposed part
19 Electrode component part
20 Current collector lead
21 Insulation tape
22 Uncoiler
23 Uncolier-side guide roller
24, 37, 40 Dancer roller mechanism
24a, 37a, 40a Supporting roller
24b, 37b, 40b Dancer roller
27 Anti-snaking roller mechanism
27a Roller
28 Groove forming mechanism
29 Feeding-and-wrapping guide roller
30 Groove forming roller
31 Groove forming roller
30a, 31a Groove forming protrusion
30b, 31b Roller shaft
32 Auxiliary drive roller
32a Roller shaft
33 Extracting-and-wrapping guide roller
34 Direction changing guide roller
38 Secondary drive roller
49 Auxiliary transfer roller
41 Coiler-side guide roller
42 Coiler
43, 44 Gear
47, 48 Ball bearing
47a, 48a Ball
47b, 48b Bearing holder
49 Stopper
50, 51 Air cylinder
52, 53 Air pipe
54 Precise decompression valve
57 Air pump
58 Auxiliary transfer force-applying air cylinder
59, 60, 61, 62 Dust collecting nozzle

1. A negative electrode for a nonaqueous battery including an active material layer formed on a surface of a current collector core, the negative electrode comprising:
a double-coated part which includes the active material layer formed on each surface of the current collector core;
a core exposed part which is located at an end of the current collector core, and does not include the active material layer; and
a single-coated part which is located between the double-coated part and the core exposed part, and includes the active material layer formed only on one of the surfaces of the current collector core, wherein
a plurality of grooves are formed in each surface of the double-coated part to be inclined relative to a longitudinal direction of the negative electrode, while the grooves are not formed in the single-coated part,
a negative electrode current collector lead is connected to the core exposed part, and
the negative electrode is wound in such a manner that the core exposed part constitutes a last wound end.

2. The negative electrode for the nonaqueous battery of claim 1, wherein
a phase of the grooves formed in one of the surfaces of the double-coated part is symmetric with a phase of the grooves formed in the other surface of the double-coated part.

3. The negative electrode for the nonaqueous battery of claim 1, wherein
a depth of the grooves formed in each of the surfaces of the double-coated part is in the range of 4 μm to 20 μm.

4. The negative electrode for the nonaqueous battery of claim 1, wherein
the grooves formed in each of the surfaces of the double-coated part are arranged at a pitch of 100 μm to 200 μm in the longitudinal direction of the negative electrode.

5. The negative electrode for the nonaqueous battery of claim 1, wherein
the grooves formed in each of the surfaces of the double-coated part extend from one lateral end to the other lateral end of the negative electrode.

6. The negative electrode for the nonaqueous battery of claim 1, wherein
the grooves formed in one of the surfaces of the double-coated part, and the grooves formed in the other surface of the double-coated part are inclined at an angle of 45° relative to the longitudinal direction of the negative electrode in different directions, so as to extend in directions crossing each other at right angles.

7. The negative electrode for the nonaqueous battery of claim 1, wherein
the negative electrode current collector lead, and the active material layer of the single-coated part are arranged on the opposite surfaces of the current collector core.

8. An electrode group for a nonaqueous battery comprising:
a positive electrode and a negative electrode wound with a separator interposed therebetween, wherein
the positive electrode includes a positive electrode active material layer formed on each surface of a positive electrode current collector core,
the negative electrode is the negative electrode of claim 1, and
the single-coated part of the negative electrode constitutes an outermost turn of the electrode group.

9. The electrode group for the nonaqueous battery of claim 8, wherein
the surface of the current collector core in the single-coated part of the negative electrode on which the active material layer is not formed constitutes an outermost circumferential surface of the electrode group.

10. A method for producing an electrode group for a nonaqueous battery comprising:
preparing a positive electrode including a positive electrode active material layer formed on each surface of a positive electrode current collector core;
preparing the negative electrode of claim 1; and
winding the positive electrode and the negative electrode with a separator interposed therebetween in such a manner that the core exposed part of the negative electrode constitutes a last wound end.

11. A cylindrical nonaqueous secondary battery, wherein
the electrode group of claim 8 is contained in a battery case,
a predetermined amount of a nonaqueous electrolyte is injected in the battery case, and
an opening of the battery case is hermetically sealed.

12. A method for producing the cylindrical nonaqueous secondary battery of claim 11, the method comprising:
preparing a positive electrode including a positive electrode active material layer formed on each surface of a positive electrode current collector core;
preparing the negative electrode of claim 1;
winding the positive electrode and the negative electrode with a separator interposed therebetween in such a manner that the core exposed part of the negative electrode constitutes a last wound end, thereby producing an electrode group; and
introducing the electrode group and the nonaqueous electrolyte in the battery case, and sealing the battery case.
